(19) United States
(12) Patent Application Publication
(10) Pub. No.: US 2010/0122073 A1
(43) Pub. Date: May 13, 2010

(54) HANDLING EXCEPTIONS IN SOFTWARE TRANSACTIONAL MEMORY SYSTEMS

(76) Inventors: Ravi Narayanaswamy, San Jose, CA (US); Xinmin Tian, Union City, CA (US); Bratin Saha, Santa Clara, CA (US); Ali-Reza Adl-Tabatabai, San Jose, CA (US); Robert Geva, Cupertino, CA (US); Clark Nelson, Hillsboro, OR (US); Sergey Preis, Novosibirsk (RU); Sergey Kozhukhov, Novosibirsk (RU); Aleksei G. Cherkasov, Novosibirsk (RU)

Correspondence Address: INTEL CORPORATION;c/o CPA Global, P.O. BOX 52050, MINNEAPOLIS, MN, 55402, US

(21) Appl. No.: 12/268,276

(22) Filed: Nov. 10, 2008

(51) Int. Cl. G06F 9/30

(52) U.S. Cl. 712/244; 712/E09.016

(57) ABSTRACT

A method and apparatus for handling exceptions during execution of a transaction is herein described. A compiler associates a transaction exception handler (TEH) with a transaction in program code, such as through insertion of a call to the TEH. The TEH is also associated with an exception data structure, such as an unwind table, that is utilized during runtime to call an appropriate handler in response to an exception. Additionally, the TEH code is generated by the compiler and inserted into the program code. Upon encountering an exception during execution of the transaction, the TEH is capable of dynamically resizing the transaction to the point of the exception through an attempted commit.

### FIELD

This invention relates to the field of processor execution and, in particular, to execution of groups of instructions.

### BACKGROUND

Advances in semi-conductor processing and logic design have permitted an increase in the amount of logic that may be present on integrated circuit devices. As a result, computer system configurations have evolved from a single or multiple integrated circuits in a system to multiple cores and multiple logical processors present on individual integrated circuits. A processor or integrated circuit typically comprises a single processor die, where the processor die may include any number of cores or logical processors.

The ever increasing number of cores and logical processors on integrated circuits enables more software threads to be concurrently executed. However, the increase in the number of software threads that may be executed simultaneously have created problems with synchronizing data shared among the software threads. One common solution to accessing shared data in multiple core or multiple logical processor systems comprises the use of locks to guarantee mutual exclusion across multiple accesses to shared data. However, the ever increasing ability to execute multiple software threads potentially results in false contention and a serialization of execution.

For example, consider a hash table holding shared data. With a lock system, a programmer may lock the entire hash table, allowing one thread to access the entire hash table. However, throughput and performance of other threads is potentially adversely affected, as they are unable to access any entries in the hash table, until the lock is released. Alternatively, each entry in the hash table may be locked. Yet, the complexity for a programmer to manage a lock for each entry becomes extremely cumbersome. Either way, after extrapolating this simple example into a large scalable program, it is apparent that the complexity of lock contention, serialization, fine-grain synchronization, and deadlock avoidance is an extremely large burden for programmers.

Another recent data synchronization technique includes the use of transactional memory (TM), which may also be referred to as transactional execution. Often transactional memory includes executing a group of a plurality of micro-operations, operations, or instructions. This group of operations/instructions is usually referred to as an atomic or critical section. In the example above, both threads execute within the hash table, and their accesses are monitored/tracked. If both threads access/alter the same entry, conflict resolution may be performed to ensure data validity. One type of transactional execution includes a Software Transactional Memory (STM), where accesses are tracked, conflict resolution, abort tasks, and other transactional tasks are primarily performed in software.

To accomplish tracking memory accesses in an STM, access barriers are inserted by a compiler at memory accesses in transactional program code. These accesses barriers are executed when one of the memory accesses are encountered to ensure data validity in the system. These barriers are usually robust in detecting potential conflicts that may lead to invalid data. However, other common events, such as exceptions during runtime, have not been efficiently handled in current STM systems.

### BRIEF DESCRIPTION OF THE DRAWINGS

The present invention is illustrated by way of example and not intended to be limited by the figures of the accompanying drawings.

FIG. 1 illustrates an embodiment of a processor including multiple processing elements capable of executing multiple software threads.

FIG. 2 illustrates an embodiment of a Software Transaction Memory (STM) system.

FIG. 3 illustrates an embodiment of a flow diagram for a method of providing for handling of exceptions in transactions.

FIG. 4 illustrates another embodiment of a flow diagram for a method of providing for handling of exceptions in transactions.

FIG. 5 illustrates an embodiment of a flow diagram for a method of dynamically resizing a transaction through handling of an exception within the transaction.

FIG. 6 illustrates an embodiment of a flow diagram for handling an exception during execution of a transaction.

### DETAILED DESCRIPTION

In the following description, numerous specific details are set forth such as examples of specific Software Transactional Memory (STM) systems, specific programming languages, specific programming statements, etc. in order to provide a thorough understanding of the present invention. It will be apparent, however, to one skilled in the art that these specific details need not be employed to practice the present invention. In other instances, well known components or methods, such as alternate transactional memory implementations, demarcation/identification of transactions, specific multi-core and multi-threaded processor architectures, transaction hardware, cache organizations, specific compiler methods, implementations, and phases, have not been described in detail in order to avoid unnecessarily obscuring the present invention.

The method and apparatus described herein are for efficiently handling exceptions during execution of transactions. Specifically, exception handling is primarily discussed in reference to an illustrative optimistic read Software Transactional Memory system (STM). However, the methods and apparatus for efficient exception handling are not so limited, as they may be implemented in associated with any transactional memory system.

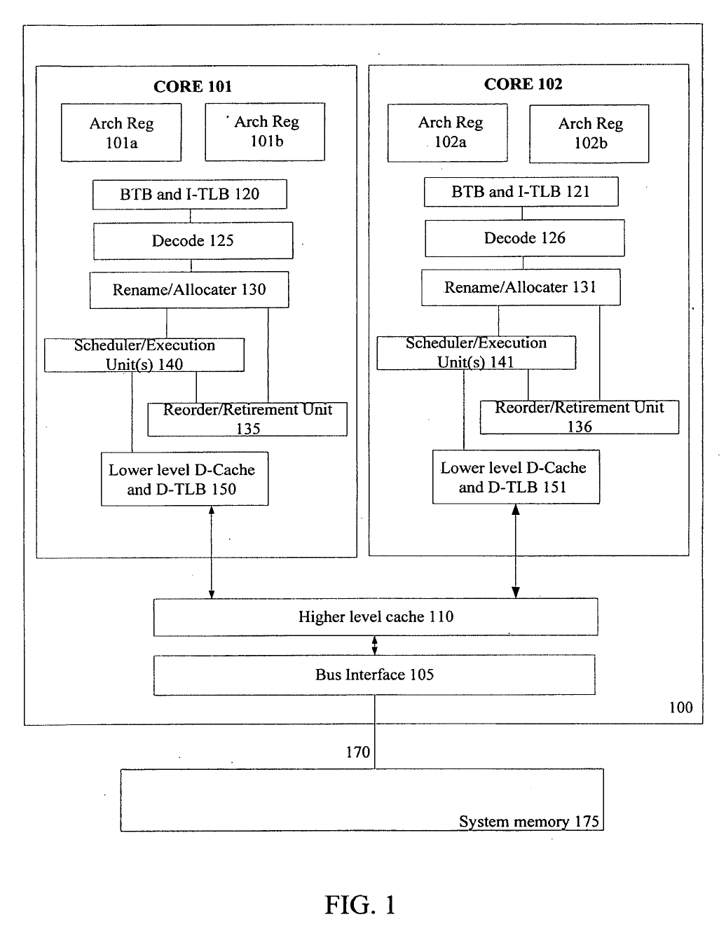

Referring to FIG. 1, an embodiment of a processor capable of executing code for a Software Transactional Memory (STM) is illustrated. Note, as discussed above, processor 100 may also include hardware support for hardware transactional execution and/or hardware acceleration of an STM. Processor 100 includes any processor, such as a micro-processor, an embedded processor, a digital signal processor (DSP), a network processor, or other device to execute code. Processor 100, as illustrated, includes a plurality of processing elements.

In one embodiment, a processing element refers to a thread unit, a process unit, a context, a logical processor, a hardware thread, a core, and/or any other element, which is capable of holding at least a portion of a state for a processor, such as an execution state or architectural state. In other words, a processing element, in one embodiment, refers to any hardware capable of being independently associated with code, such as a software thread, operating system, application, virtual machine, or other code. A physical processor typically refers to an integrated circuit, which potentially includes any number of other processing elements, such as cores or hardware threads.

A core often refers to logic located on an integrated circuit capable of maintaining an independent architectural state wherein each independently maintained architectural state is associated with at least some dedicated execution resources. In contrast to cores, a hardware thread, which may also be referred to as a physical thread, typically refers to any logic located on an integrated circuit capable of maintaining at least a portion of an independent architectural state wherein the independently maintained architectural state share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores, core 101 and 102, which share access to higher level cache 110. Although processor 100 may include asymmetric cores, i.e. cores with different configurations, functional units, and/or logic, symmetric cores are illustrated in FIG. 1. As a result, core 102, which is illustrated as identical to core 101, will not be discussed in detail to avoid repetitive discussion. In addition, core 101 includes two hardware threads 101a and 101b, while core 102 includes two hardware threads 102a and 102b. Therefore, software entities, such as an operating system, potentially view processor 100 as four separate processors, i.e. four processing elements capable of independently executing four active software threads.

Here, a first thread is associated with architecture state registers 101a, a second thread is associated with architecture state registers 101b,a third thread is associated with architecture state registers 102a, and a fourth thread is associated with architecture state registers 102b. As illustrated, architecture state registers 101a are replicated in architecture state registers 101b, so individual architecture states/contexts are capable of being stored for logical processor 101a and logical processor 101b. Other smaller resources, such as instruction pointers and renaming logic in rename allocator logic 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register, low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of exemplary functional units/resources of a processor is illustrated. Note that a processor may include, or omit, any of these functional units, as well as include any other known functional units, logic, or firmware not depicted.

As illustrated, processor 100 includes bus interface module 105 to communicate with devices external to processor 100, such as system memory 175, a chipset, a northbridge, or other integrated circuit. Memory 175 may be dedicated to processor 100 or shared with other devices in a system. Higher-level or further-out cache 110 is to cache recently fetched elements from higher-level cache 110. Note that higher-level or further-out refers to cache levels increasing or getting further way from the execution unit(s). In one embodiment, higher-level cache 110 is a second-level data cache. However, higher level cache 110 is not so limited, as it may be associated with or include an instruction cache. A trace cache, i.e. a type of instruction cache, may instead be coupled after decoder 125 to store recently decoded traces. Module 120 also potentially includes a branch target buffer to predict branches to be executed/taken and an instruction-translation buffer (I-TLB) to store address translation entries for instructions.

Decode module 125 is coupled to fetch unit 120 to decode fetched elements. In one embodiment, processor 100 is associated with an Instruction Set Architecture (ISA), which defines/specifies instructions executable on processor 100. Here, often machine code instructions recognized by the ISA include a portion of the instruction referred to as an opcode, which references/specifies an instruction or operation to be performed.

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

In one embodiment, processor 100 is capable of transactional execution. A transaction, which may also be referred to as a critical or atomic section of code, includes a grouping of instructions, operations, or micro-operations to be executed as an atomic group. For example, instructions or operations may be used to demarcate a transaction or a critical section. Typically, during execution of a transaction, updates to memory are not made globally visible until the transaction is committed. In other words, modifications to shared data in a transaction are not visible to other threads until the transaction is committed. While the transaction is still pending, locations loaded from and written to within a memory are tracked. Upon successful validation of those memory locations, the transaction is committed and updates made during the transaction are made globally visible.

However, if the transaction is invalidated during its pendancy, the transaction is restarted without making the updates globally visible. As a result, pendency of a transaction, as used herein, refers to a transaction that has begun execution and has not been committed or aborted, i.e. pending. Example implementations for transactional execution include a Hardware Transactional Memory (HTM) system, a Software Transactional Memory (STM) system, and a combination thereof.

A Hardware Transactional Memory (HTM) system often refers to tracking access during execution of a transaction in hardware of processor 100. For example, cache 150 is to cache a data item/object from system memory 175 for use by processing elements 101a and 101b. During execution of a transaction, an annotation/attribute field is associated with a cache line in cache 150, which is to hold the data object. The annotation field is utilized to track accesses to and from the cache line. In one embodiment, if a write to a cache line that has previously tracked a load during a transaction occurs, then a data conflict is detected utilizing the cache line annotations.

A Software Transactional Memory (STM) system often refers to performing access tracking, conflict resolution, or other transactional memory tasks in, or at least partially in, software. As a general example, a compiler, when executed, compiles program code to insert calls to read and write barriers for transactional load and store operations, accordingly. A compiler may also insert other transactional and non-transaction related operations, such as commit operations, abort operations, bookkeeping operations, conflict detection operations, and strong atomicity operations.

In one embodiment, during compilation of program code, a compiler associates a transaction with a transaction exception handler. As a result, during execution of the program code, a transaction memory system is capable of handling synchronous exceptions encountered during execution of the transaction. In one embodiment, execution of the transaction exception handler is part of an unwinding process associated with the exception, where the handler is executed with the purpose of attempting to commit the transaction at the point of exception. In other words, transactions may be dynamically resized by attempting to commit a transaction anywhere within the transaction region that an exception is thrown.

Processor 100, as described above, potentially executes compiler code held in an article of manufacture, such as system memory 175, to compile application code or program code, which may be held in the same article of manufacture or a separate storage device. Either in conjunction with compilation or separately after compilation, processor 100 may be utilized to execute the program code including transactions, inserted exception handlers, and other inserted code to perform both STM operations and non-STM operations.

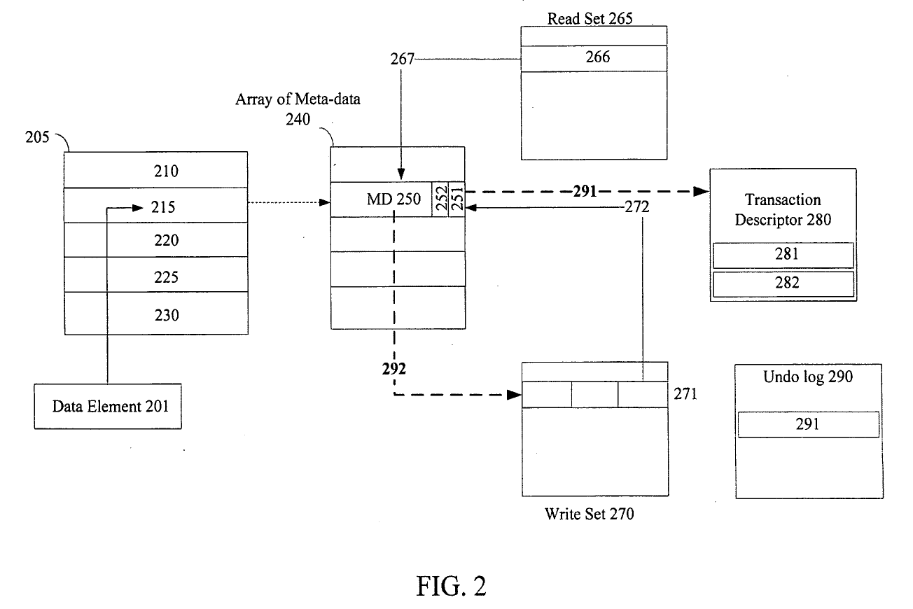

Referring to FIG. 2, a simplified illustrative embodiment of a S™ system is depicted. Note that the discussion of FIG. 2 is primarily in reference to an optimistic read STM system. In that regard, discussion of certain transactional memory implementation details, such as direct versus indirect referencing, optimistic versus pessimistic concurrency control, and update-in place versus write-buffering are provided to illustrate a few of the design choices that may be made when implementing a transactional memory system. However, the methods and apparatus described herein for efficient exception handling may be implemented in any transactional memory system, such as a hardware accelerated STM, a hybrid STM, a pessimistic STM, or other known transactional memory system, as well as in conjunction with any known implementation details.

In one embodiment of an STM, memory locations and/or data elements, such as data element 201 to be held in cache line 215, are associated with meta-data locations, such as meta-data location 250 in array 240. As an illustrative example, an address, or a portion thereof, associated with data element 201 and/or line 215 of cache memory 205 is hashed to index location 250 in array 240. Often, in regards to transactional memory, meta-data location 250 is referred to as a transaction record, while array 240 is referred to as an array of transaction records. Although transaction record 250, as illustrated, is associated with a single cache line, a transaction record may be provided at any data granularity level, such as a size of data element 201, which may be smaller or larger than cache line 215, as well as include an operand, an object, a class, a type, a data structure, or any other element of data.

Often in a STM, transaction record (TR) 250 is utilized to provide different levels of ownership of and access to an associated memory address, such as data element 201. In one embodiment, TR 250 holds a first value to represent an unlocked or un-owned state and holds a second value to represent a locked or owned state. In some implementations, TR 250 may be capable of multiple different levels of locked or owned states, such as a write lock/exclusive lock state to provide exclusive ownership to a single owner, a read lock where reader(s) read data element 201 while allowing others to still read but not write data element 201, and a read lock with intent to upgrade to a write/exclusive lock state where a potential writer wants to acquire an exclusive write-lock but is waiting for current readers to release data element 201.

The values utilized to represent unlocked states and locked states in TR 250 vary based on the implementation. For example, in one embodiment of an optimistic concurrency control STM, TR 250 holds a version or timestamp value to indicate an unlocked state and holds a reference, such as a pointer, to a transaction descriptor, such as transaction descriptor 280, to represent a locked state. Usually, transaction descriptor 280 holds information describing a transaction, such as transaction ID 281 and transaction state 282. The above described example of utilizing a pointer to transaction descriptor 280 may often be referred to as a direct reference STM, where transaction record 250 holds a direct reference to owning transaction 281.

In another embodiment, an owned or locked value includes a reference to a write set entry, such as write entry 271 of write set 270. In one embodiment, write entry 271 is to hold a logged version number from transaction record 250 before the lock is acquired, a pointer to transaction descriptor 280 to indicate that transaction 281 is associated with write entry 271, and a back pointer to transaction record 250. This example is often referred to as an indirect reference STM, where TR 250 references an owning transaction indirectly, i.e. through write entry 271.

In contrast to a version or pointer value in TR 250, in one embodiment of a pessimistic concurrency control STM, TR 250 holds a bit vector, where higher order bits represent executing transactions, while LSB 251 and 2^{nd} LSB 252 represent a write lock state, an unlocked state, and a read upgrade to write lock state. In an unlocked state, the higher bits that are set represent corresponding transactions that have read data element 201. In a locked state, one of the higher bits are set to indicate which of the transactions has write locked data element 201.

In one embodiment, an access barrier is executed upon a memory access to date element 201 to ensure proper access and data validity. Here, an ownership test is often performed to determine the ownership state of TR 250. In one embodiment, a portion of TR 250, such as LSB 251 and/or 2^{nd} LSB 252, is utilized to indicate availability of data element 201. To illustrate, when LSB 251 holds a first value, such as a logical zero, then TR 250 is unlocked, and when LSB 251 holds a second value, such as a logical one, then TR 250 is locked. In this example, second LSB 252 may be utilized to indicate when a read owner intends to upgrade to an exclusive write lock. Alternatively, the combination of bits 251-252, as well as other bits, may be utilized to encode different ownership states, such as the multiple lock states described above.

In one embodiment, barriers at memory accesses perform bookkeeping in conjunction with the ownership tests described above. For example, upon a read of data element 201, an ownership test is performed on TR 250. If unlocked, i.e. holding a version value in an optimistic concurrency control STM, the version value is logged in read entry 265 of read set 266. Later, upon validation, which may be on-demand during pendency of the transaction or at commit of the transaction, a current value of TR 250 is compared to the logged value in entry 266. If the values are different, then either another owner has locked TR 250 and/or modified data element 201, which results in a potential data conflict. Additionally, a write barrier may perform similar bookkeeping operations for a write to data element 201, such as performing an ownership test, acquiring a lock, indicating an intent to upgrade the lock, managing write set 270, etc.

Previously, at the end of a transaction, a commit of the transaction is attempted. As an example, a read set is validated to ensure locations read from during pendency of the transaction are valid. In other words, a logged version value held in read entry 266 is compared against a current value held in transaction record 250. If the current value is the same as the logged version, then no other access has updated data element 201. Consequently, the read associated with entry 266 is determined to be valid. If all the memory accesses are determined to be valid, then the transaction is committed.

However, if the versions are different and the current transaction did not read and then write to the data element, then another transaction either acquired a lock of TR 250 and/or modified data element 201. As a result, the transaction may then be aborted. Once again, depending on the implementation of the STM, the operations performed by the commit and abort functions may be interchangeable. For example, in a write-buffering STM, writes during a pendency of the transaction are buffered, and upon commit they are copied into the corresponding memory locations. Here, when the transaction is aborted, new values in the write-buffer are discarded. Inversely, in an update-in-place STM, the new values are held in the corresponding memory locations, while the old values are logged in a write log. Here, upon abort, the old values are copied back to the memory locations, and on a commit, the old values in the write log are discarded.

Whether in a write-buffering STM or in an update-in-place STM, when roll-back of updated memory locations is needed, often an undo log, such as undo log 290 is utilized. As an example, undo log 290 includes entries, such as entry 291, to track updates to memory during a transaction. To illustrate, in an update-in-place STM, memory locations are updated directly. However, upon an abort, the updates are discarded based on undo log 290. In one embodiment, undo log 290 is capable of rolling back nested transactions. Here, undo log 290 potentially rolls back a nested transaction without invalidating higher/outer level transactions, such as rolling back to a checkpoint immediately before the start of the nested transaction.

As discussed above, previous access barriers, commit functions, and abort functions have not efficiently provided for handling of synchronous exceptions during execution of transactions. Therefore, in one embodiment, a compiler associates a transaction exception handler with a transaction in program code. Consequently, when an exception is thrown within the transaction, the exception is efficiently handled. In one embodiment, the exception may be thrown at any point within the transaction. As an example, the transaction exception handler attempts to commit the transaction at that point. As a result, the ability to handle an exception and attempt a commit at that point potentially results in an advantageous dynamic resizing of the transaction to the point of the exception.

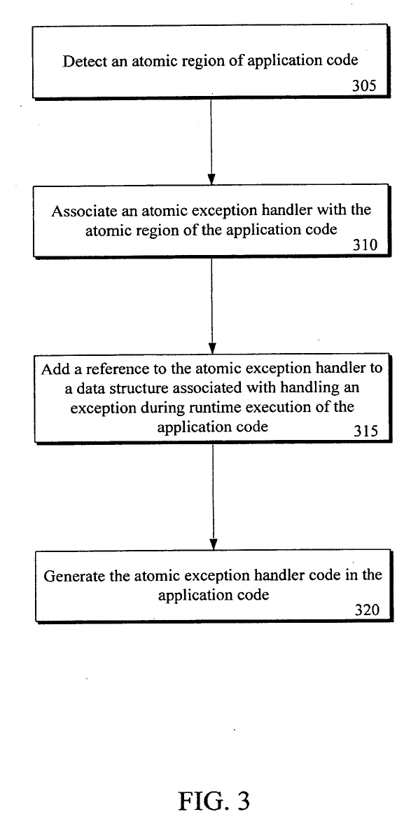

Referring next to FIG. 3, an embodiment of a flow diagram for a method of enabling efficient exception handling within transactions is illustrated. Although the flows of FIGS. 3-6 are illustrated in a substantially serial fashion, the methods they depict are not so limited, as any of the flows may be performed in a different order, as well as in parallel.

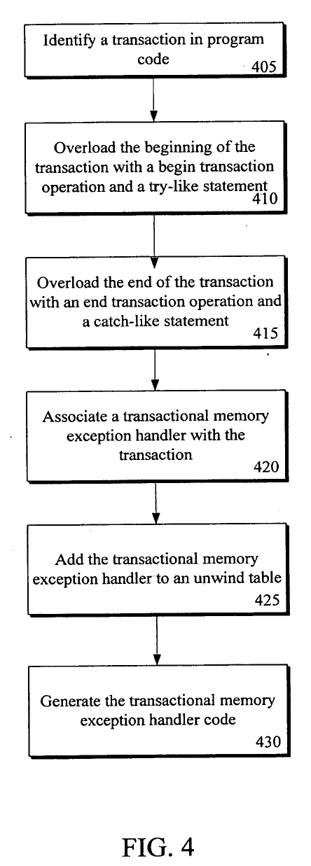

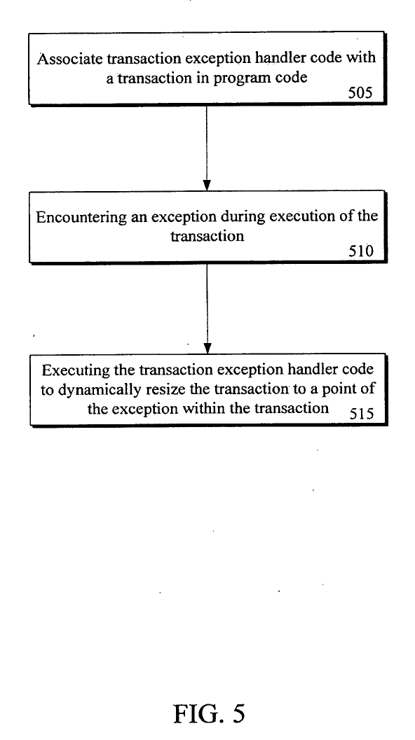

In one embodiment, flows may be at least partially performed during execution of already compiled program code, such as flow 510 in FIG. 5, where an exception is encountered during execution of a transaction. In another embodiment, flows are performed during compilation of program/application code through execution of a compiler to compile application code, such as the flows depicted in FIG. 4. Consequently, some flows may only be discussed from a compiler or runtime perspective; however, each flow potentially supports both compiler operations and runtime actions. In addition, these compiler/runtime actions may be combined through runtime compilation of application code that is being executed, i.e. compiling transactional code and executing it on the fly.

In one embodiment, a compiler includes a program or set of programs to translate source text/code into target text/code. Often compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle end, which illustrates the blurring of delineation between a front-end and back end of a compiler. As a result, reference to insertion, association, generation, or other operation of a compiler may take place in any of the aforementioned phases or passes, as well as any other known phases or passes of a compiler.

An atomic region of application/program code is detected in flow 305. In regards to transactional execution, an atomic block of instructions and/or operations is often referred to as an atomic block/region, a critical section, a transactional region, or a transaction. Detecting an atomic section of code may be performed through any known method of detecting or identifying a critical/atomic section of code. For example, identification of such a block of instructions/operations in an STM may be performed explicitly, i.e. through demarcation of the transaction in code, or implicitly, i.e. a compiler forming a group of instructions into a critical section. In one embodiment, a transactional region is demarcated by begin and end instructions, which may include specific start and end transaction instructions, acquire a lock and a release a lock instructions, or other statements defining boundaries of a transaction.

In one embodiment, a compiler overloads the transaction begin with a begin transaction instruction and a try statement. Additionally, the transaction end is overloaded with an end transaction operation and a catch statement. Here, overload refers to the potential insertion of two operations/statements at a point in the program. As an example, in programming languages, such as C++, a try-catch framework may be utilized to enable usage of a transaction exception handler in a similar fashion to that of a destructor handler.

In flow 310, an atomic exception handler is associated with the atomic region of the application code. Any known method of associating a handler with a section of code may be utilized. In one embodiment, a compiler inserts a call, such as an indirect call, to the atomic/transactional exception handler at the atomic region of the application code, which may be included within a transactional section or at the boundary thereof. As a specific example, during front-end compilation, such as at the parsing phase, the call to the transactional exception handler is inserted.

In this example, the back-end sees the call as inserted by the user at the front-end, which potentially aides in the validity of underlying data structures through the entire compilation process. Here, the atomic exception handler is lowered during a later phase, such as in the transformation phase to support consolidation of a transactional memory runtime library in one place. In other words, the compiler generates and/or inserts the atomic exception handler code in the back-end, such as in flow 320, which is discussed in more detail below.

In flow 315 a reference to the atomic exception handler is added to a data structure associated with handling an exception during runtime execution of the application code. Essentially, the compiler is registering the exception handler within the code, such that during runtime upon encountering an exception, the execution appropriately vectors to the atomic exception handler. In one embodiment, the data structure includes a table or stack, such as an unwind table. Here, the compiler adds the atomic exception handler to the unwind table, which is utilized during exception handling. As an example, the back-end adds the atomic exception handler to the unwind table.

In flow 320, the atomic exception handler code is generated/inserted in the application code. In one embodiment, the transactional/atomic handler code is generated in the back-end transactional memory transformation pass. As a first example, different transactional handlers or different code in a unified handler may be generated based on any number of attributes of transactions, such as nesting depth of a transaction, default actions to attempt, or user calls/inputs.

A transactional/atomic exception handler may perform any known exception handling operations separately, or in combination with, normal transactional memory operations. In one embodiment, the exception handler is to attempt to commit the transaction. In fact, as one example, the handler, by default, attempts to commit the transaction. Therefore, if an exception is thrown at a dynamic point in the transaction, then the transaction attempts to commit at that point; this allows for exceptions to dynamically resize a transaction. Here, operations to perform the validation and other commit operations are inserted, which may include a call within the handler to normal transactional memory library functions, such as a commit or abort function.

Additionally, in one example, a compiler may provide support for an explicit user abort to provide the user with an option to abort the transaction upon encountering an exception, instead of committing the transaction. Although in example discussed above, the default by the handler is to attempt to commit the transaction, the handler is not so limited, as it may abort by default and allow for an explicit user commit. In addition, reference to different phases of a compiler is purely illustrative, as any of the flows for methods described may be performed during any phase of compilation or during runtime execution.

Referring next to FIG. 4, an illustrative embodiment of a flow diagram of another method for enabling efficient exception handling within transactions is illustrated. In flow 405, a transaction/critical section is identified in program code. As stated above, the transaction may be demarcated by transaction/atomic statements or lock instructions.

In flow 410, the beginning boundary of the transaction is overloaded with a begin transaction operation and a try-like statement. For example, the start boundary of the transaction is compiled into a try statement and a start transaction statement. Similarly, in flow 415 the end of the transaction is overloaded with an end transaction statement and a catch-like statement. Continuing the example, an end to the transaction statement, and an end to the try statement, such as a catch or throw statement, is inserted at the end boundary of the transaction. Note that the catch or throw statement may included explicit user handler instructions, such as the explicit user abort call discussed herein.

In flow 420, a transactional memory exception handler is associated with the transaction. In one embodiment, a call statement to the transactional memory exception handler is inserted in the transaction, such as at the ending boundary of the transaction. Note that the use of the term within the transaction is relative, where a call may be placed after the ending boundary of the transaction; yet, a try statement invokes the call in response to an exception thrown while the transaction is pending, i.e. within the transaction. Furthermore, in flow 425, the transactional memory exception handler is added to an unwind table. Here, a reference to the handler is inserted at/added to a data structure to register the handler with the unwinding process for handling of an exception during a pendency of a transaction.

In flow 430 the transactional memory exception handler (TMEH) code is generated. As stated above, the TMEH code may include any exception handler related operations, as well as any transactional memory related operations. In one embodiment, the TMEH code is to, by default, attempt to commit the transaction. Here, the TMEH code may also provide for an explicit user abort. In addition, the TMEH code is potentially generated based on handling a nesting depth of the transaction.

In FIG. 4, any of the flows may be performed during any phase of compilation. For example, flows 404-420 are performed in front-end phases of compilation, such as the parsing phase, while flows 425-430 are performed in back-end phases of compilation, such as the transformation phase. However, the phases of compilation are not so limited, as any of the flows may be performed during any of the phases, including during runtime compilation.

Turning to FIG. 5, an embodiment of a flow diagram for a method of dynamically resizing a transaction through handling of an exception is illustrated. In flow 505 a transaction exception handler (TEH) is associated with a transaction in program code. In one embodiment, the TEH is associated with the transaction through insertion of a call to the TEH at the transaction in the program code. In another embodiment, during runtime when an exception is encountered, a general exception handler vectors execution to the TEH in response to the exception occurring within a transaction.

During execution of the program code, and specifically, during execution of the transaction an exception is thrown in flow 510. An exception may include any known exception event, such as a synchronous event that is a condition originally created by the user, such as a failure during a try-catch statement.

In flow 515, the TEH is executed, in response to the exception being encountered during execution of the transaction, to dynamically resize the transaction to a point of the exception within the transaction. In one embodiment, the TEH is executed as part of an unwinding process based on an association of the TEH in an unwinding table. As an example, dynamic resizing involves the TEH, by default, attempting to commit the transaction at the point of the exception. Here, assume an atomic block of code includes ten instructions or operations. If an exception is thrown after the sixth operation and the TEH is executed, then the TEH calls a commit function by default, which attempts to commit the transaction after the sixth instruction, i.e. the point of the exception. Essentially, the transaction is resized from the original ten operations to six operations.

However, a user may wish to enforce the all or nothing nature of a transaction. Therefore, in one embodiment, the program code and/or the TEH is capable of supporting an explicit user-abort, where an abort function is called to abort the transaction instead of committing the transaction in response to an explicit user abort call. Note this call may be performed in the TEH or other code associated with the transaction.

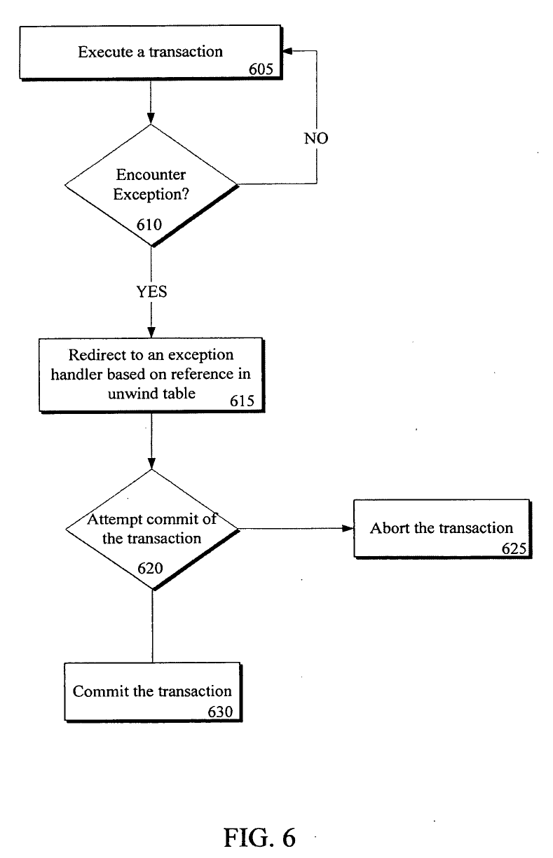

In reference to FIG. 6, an embodiment of a flow diagram for a method of handling an exception during execution of a transaction is illustrated. In flow 605 a transaction is executed. In one embodiment, a transaction is executed utilizing an STM, which may include a full STM, a hardware accelerated STM, or a hardware executed transaction that has exceeded the capacity of hardware and is now utilizing STM characteristics. Note that it is not necessary that a transaction be executed utilizing an STM to handle an exception in this manner; however, an STM is utilized below to describe an embodiment of handling an exception. Therefore, in one embodiment, a start transaction operation is executed to begin execution of an atomic section of code in flow 605.

In flow 610, an exception is encountered. In one embodiment, an exception includes a synchronous exception thrown through execution of code. As an example, an exception is thrown as part of a throw statement. Although synchronous exceptions thrown as a result of conditional code has been discussed, any known exception may be encountered at this point. Also note that if no exception is encountered, then execution continues normally back to flow 605.

In flow 615 execution is redirected to an exception handler based on a reference to an unwind table. As an example, a compiled C++ program includes the transaction, and during a try statement associated with the transaction, a synchronous exception is thrown. As part of the C++ program constructs an unwind table is utilized to invoke the exception handler as part of the normal unwinding process.

The exception handler, in flow 620, attempts to commit the transaction. In one embodiment, the attempt to commit the transaction at the point of the exception is a default action of the exception handler. To provide an illustration, the exception handler's attempt to commit the transaction may include execution of a call to a transaction commit function, which performs the necessary validation, such as read-set validation, and other commit operations.

Alternatively, in flow 625, the transaction may be aborted. In one scenario, an abort of the transaction potentially results from unsuccessfully validating the transaction during an attempted commit, such as a load being determined invalid. However, in one embodiment, the exception handler provides for a user-abort, such that the transaction is aborted before attempting to commit in response to an explicit user abort input.

Therefore, as can be seen from above, a compiler may efficiently provide for handling of exceptions during execution of transactions. Previously, handling of exceptions during transactions was not provided for, which potentially severely limits the application of transactional memory in several programming language environments, such as C++. However, by associating a transaction exception handler with a transaction, which by default attempts to commit the transaction, an exception within a transaction is capable of not only being handled but also dynamically resizes the transaction to the point of the exception.

A module as used herein refers to any hardware, software, firmware, or a combination thereof. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices. However, in another embodiment, logic also includes software or code integrated with hardware, such as firmware or micro-code.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical storage device, optical storage devices, acoustical storage devices or other form of propagated signal (e.g., carrier waves, infrared signals, digital signals) storage device; etc. For example, a machine may access a storage device through receiving a propagated signal, such as a carrier wave, from a medium capable of holding the information to be transmitted on the propagated signal.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An article of manufacture including program code which, when executed by a machine, causes the machine to perform the operations of:
detecting an atomic region of application code; and
associating an atomic exception handler with the atomic region of the application code.

2. The article of manufacture of claim 1, wherein associating the atomic exception handler with the atomic region of the application code includes inserting a call to the atomic exception handler at the atomic region of the code.

3. The article of manufacture of claim 2, wherein the program code which, when executed by the machine, causes the machine to further perform the operations of:
associating the atomic exception handler with a data structure that is to identify an appropriate handler in response to an exception during runtime execution of the application code.

4. The article of manufacture of claim 3, wherein the program code includes compiler code to compile the application code, and wherein inserting the call to the atomic exception handler is performed during a front-end phase of compilation of the application code.

5. The article of manufacture of claim 4, wherein the data structure includes an unwind table, and wherein associating the atomic exception handler with the unwind table comprises adding the atomic exception handler to the unwind table during a back-end phase of compilation of the application code.

6. The article of manufacture of claim 5, wherein the program code which, when executed by the machine, causes the machine to further perform the operations of:
generating the atomic exception handler code in the application code during the back-end phase of compilation of the application code.

7. The article of manufacture of claim 6, wherein the atomic exception handler code includes operations based on a nesting depth of the atomic region of the application code.

8. The article of manufacture of claim 6, wherein generating the atomic exception handler code in the application code during the back-end phase of compilation of the application code includes inserting the atomic exception handler code during a transformation phase of compilation of the application code, the atomic exception handler code, when executed, to attempt to commit the atomic region of code by default.

9. The article of manufacture of claim 1, wherein detecting an atomic region of application code includes identifying a start of the atomic region and an end of the atomic region in the application code, and wherein the program code which, when executed by the machine, causes the machine to further perform the operations of:
overloading the start of the atomic region with a begin atomic region instruction and a try-like statement; and
overloading the end of the atomic region with an end atomic region instruction and a catch statement.

10. The article of manufacture of claim 9, wherein the application code includes a C++ compliant application code, the start of the try-like statement includes a try statement, and the catch-like statement includes a catch statement.

11. An article of manufacture including compiler code which, when executed by a machine, causes the machine to perform the operations of:
determining a transactional region of program code;
inserting a call to an exception handler at the transactional region of the program code;
adding a reference to the exception handler to a data structure associated with handling an exception during runtime execution of the program code; and
inserting the exception handler in the program code.

12. The article of manufacture of claim 11, wherein the data structure includes an unwind table.

13. The article of manufacture of claim 11, wherein the exception handler, when executed, is to attempt to commit the transaction by default.

14. The article of manufacture of claim 11, wherein the exception handler is capable of supporting an explicit user abort of the transactional region.

15. A system comprising:
an article of manufacture to hold compiler code, when executed, to associate transaction exception handler code with a transaction in program code, the transaction exception handler code, when executed in response to an exception within the transaction, to dynamically resize the transaction to a point of the exception within the transaction; and
a processor associated with the article of manufacture to execute the compiler code to compile the program code.

16. The system of claim 15, wherein the transaction exception handler code, when executed in response to an exception within the transaction, to dynamically resize the transaction to a point of the exception within the transaction comprises the transaction exception handler code, when executed in response to the exception within the transaction, to attempt to commit the transaction at the point of the exception.

17. The system of claim 16, wherein the transaction exception handler code, when executed in response to an exception within the transaction, to dynamically resize the transaction to a point of the exception within the transaction further comprises the transaction exception handler code, when executed in response to the exception within the transaction, to abort the transaction at the point of the exception in response to failing the attempt to commit the transaction at the point of the exception.

18. The system of claim 15, wherein the compiler code, when executed, to associate transaction exception handler code with a transaction in program code comprises:
inserting a call to the transaction exception handler code at the transaction during one phase of compilation; and
inserting the transaction exception handler code in the program during a subsequent phase of compilation.

19. A method comprising:
executing a transaction;
performing memory access tracking for the transaction;
encountering an exception during execution of the transaction;
redirecting execution to an exception handler associated with the transaction in response to encountering the exception during execution of the transaction; and
attempting to commit the transaction in response to redirecting execution to the exception handler.

20. The method of claim 19, wherein performing memory access tracking for the transaction is done at least partially in a software transactional memory system.

21. The method of claim 19, wherein redirecting execution to an exception handler associated with the transaction is based on a reference to the exception handler held in an unwind table.

22. The method of claim 19, wherein attempting to commit the transaction is a default action of the exception handler.

23. The method of claim 19, further comprising aborting the transaction in response to failing the attempt to commit the transaction in response to redirecting execution to the exception handler.

24. The method of claim 23, wherein failing the attempt to commit the transaction includes executing a user-level explicit abort after redirecting execution to the exception handler.

25. The method of claim 23, wherein failing the attempt to commit the transaction includes detecting a memory access conflict based on memory accesses tracked during performing memory access tracking for the transaction before redirecting execution to the exception handler.
